(19) United States
(12) Patent Application Publication
(10) Pub. No.: US 2020/0319780 A1
(43) Pub. Date: Oct. 8, 2020

(54) Graphical User Interface for Manipulating Securities Option Strategies

(71) Applicant: Todd H. Klump, Kirkland, WA (US)

(72) Inventor: Todd H. Klump, Kirkland, WA (US)

(21) Appl. No.: 16/829,186

(22) Filed: Mar. 25, 2020

Related U.S. Application Data
(60) Provisional application No. 62/829,269, filed on Apr. 4, 2019.

(51) Int. Cl. G06F 3/0484; G06F 3/0486; G06Q 40/04

(52) U.S. Cl. CPC G06F 3/04845; G06Q 40/04; G06F 3/04842; G06F 3/0486

(57) ABSTRACT

A graphical user interface (GUI) provided by a computing system which allows a user to indicate and manipulate options directly on a profit and loss (P&L) graph. An example method includes (i) receiving, via a GUI of a computing system, data indicative of a desired option; (ii) displaying, by the computing system, the desired option at a first location on a P&L graph; (iii) receiving, via the GUI of the computing system, data indicative of a dragging of the desired option from the first location to a second location on the P&L graph; (iv) determining, by the computing system, a quantity of the desired option corresponding to the second location; and (v) displaying, by the computing system, a P&L line corresponding to the quantity of the desired option on the P&L graph.

### CROSS-REFERENCE TO RELATED APPLICATIONS

This disclosure claims priority to U.S. Provisional Patent App. No. 62/829,269, filed on Apr. 4, 2019, which is hereby incorporated by reference in its entirety.

### USAGE AND TERMINOLOGY

In this disclosure, unless otherwise specified and/or unless the particular context clearly dictates otherwise, the terms “a” or “an” mean at least one, and the term “the” means the at least one.

In this disclosure, the term “connection mechanism” means a mechanism that facilitates communication between two or more components, devices, systems, or other entities. A connection mechanism can be a relatively simple mechanism, such as a cable or system bus, or a relatively complex mechanism, such as a packet-based communication network (e.g., the Internet). In some instances, a connection mechanism can include a non-tangible medium (e.g., in the case where the connection is wireless).

In this disclosure, the term “computing system” means a system that includes at least one computing device. In some instances, a computing system can include one or more other computing systems.

In this disclosure, the term “profit and loss (P&L) graph” means a graph defined by a first axis corresponding to an underlying asset price and a second axis corresponding to a financial result (e.g., profit or loss) at expiration.

In this disclosure, the term “strike price” means a price at which the holder of an option can buy (in the case of a call option) or sell (in the case of a put option) the underlying security when the option is exercised.

In this disclosure, the term “option price” means a price paid by a buyer to a seller for an option contract.

In this disclosure, the term “spread” means two or more option contracts in any configuration.

### FIELD

The present disclosure relates generally to graphical user interfaces, and more particularly, to graphical user interfaces that aide in the analysis and manipulation of financial securities options.

### BACKGROUND

Securities options are a contract between two parties in which the option buyer (holder) purchases the right (but not the obligation) to buy/sell a predefined number of shares of an underlying asset at a predetermined price from/to the option seller (writer) within a fixed period of time. The two types of securities options are puts and calls.

Securities options analysis tools have become increasingly sophisticated as computer programs allow option traders to model and view many aspects of options pricing. One such analysis tool is a P&L graph where the x-axis is the underlying asset price and the y-axis is profit and loss. The P&L graph, with a single options contract plotted, can show the profit or loss of that option at expiration for any value of the underlying asset.

The P&L graph is critical when analyzing complex option configurations. Options traders can create various spread trades (put and call options with different strike prices and/or different expiration dates) resulting in an almost infinite amount of profit versus risk strategies.

While the P&L graph has become the centerpiece for modeling and analyzing complex option strategies, the process of choosing which options to add to the P&L graph is a laborious task and takes a significant amount of time. Whether it be adding or subtracting long puts, short puts, long calls, short calls, options at a new strike price, moving options to a different strike price, or adding different expiration dated options, each requires the options trader to look up specific options in various tables, some of which are nested in other tables, and then use a computer mouse and/or keyboard to select the desired option within the table so it can be viewed or adjusted on the P&L graph.

The layout of the tables may or may not be conducive to creating the envisioned profit versus risk strategy. Some computer programs transfer the selected options to new tables as a filtering process while other computer programs attempt to tabulate the various option strike prices and expiration dates in an intuitive format. However, in almost all cases, the original choice of strike and/or expiration date needs to be manually changed by the user once the option(s) are viewed on the P&L graph. While an options trader sometimes can get close to a desired strategy during the tabular option lookup and selection process, getting to the final strategy is time consuming and tedious and is essentially a trial and error process.

Moreover, once an option strategy is found, analyzed, and then entered as a position, after some time it may require adjustments to bring the profit versus risk back to an acceptable level. This can get even more complicated since adjustments to complex strategies usually require multiple options to change and the options trader must envision where to add or subtract the required options contracts. Not only is the tabular lookup and selection process tedious and slow, but it is also prone to errors. For instance, a vertical spread made from calls will look identical to a vertical spread made from puts on the P&L graph. Having calls in a trade that was meant to be all puts can be a huge headache when it comes time to liquidate and exit the position. Improvements are therefore desired.

### SUMMARY

In one aspect, an example method is disclosed. The method includes (i) receiving, via a graphical user interface (GUI) of a computing system, data indicative of a desired option; (ii) displaying, by the computing system, the desired option at a first location on a P&L graph; (iii) receiving, via the GUI of the computing system, data indicative of a dragging of the desired option from the first location to a second location on the P&L graph; (iv) determining, by the computing system, a quantity of the desired option corresponding to the second location; and (v) displaying, by the computing system, a P&L line corresponding to the quantity of the desired option on the P&L graph.

In another aspect, an example computing system is disclosed. The computing system includes one or more processors and a non-transitory computer readable medium. The non-transitory computer-readable medium has stored thereon instructions that are executable to cause the computing system to perform a set of acts. The set of acts include: receiving, via a graphical user interface (GUI), data indicative of a desired option; (ii) displaying the desired option at a first location on a P&L graph; (iii) receiving, via the GUI, data indicative of a dragging of the desired option from the first location to a second location on the P&L graph; (iv) determining a quantity of the desired option corresponding to the second location; and (v) displaying a P&L line corresponding to the quantity of the desired option on the P&L graph.

In another aspect, an example non-transitory computer-readable medium is disclosed. The non-transitory computer-readable medium has stored thereon instructions that upon execution by a processor, cause performance of a set of acts including: receiving, via a graphical user interface (GUI), data indicative of a desired option; (ii) displaying the desired option at a first location on a P&L graph; (iii) receiving, via the GUI, data indicative of a dragging of the desired option from the first location to a second location on the P&L graph; (iv) determining a quantity of the desired option corresponding to the second location; and (v) displaying a P&L line corresponding to the quantity of the desired option on the P&L graph.

### BRIEF DESCRIPTION OF THE DRAWINGS

FIGS. 1A-1C depict an embodiment in which a call option is added to a P&L graph.

FIGS. 2A-2B depict an embodiment in which a put vertical spread is added to a P&L graph.

FIGS. 3A-3B depict an embodiment in which puts and calls are added to a P&L graph to create a straddle.

FIGS. 4A-4D depict an embodiment in which a put butterfly is added to a P&L graph.

FIGS. 5A-5B depict an embodiment in which puts are added to a P&L graph to create a ratio spread.

FIG. 6 is a simplified block diagram of an example computing device.

FIG. 7 is a flow chart of an example method.

### DETAILED DESCRIPTION

### I. Overview

Disclosed herein are GUI methods and systems that improve the manner in which an options trade can be manipulated for analysis. For instance, the GUI methods and systems discussed below dramatically simplify the laborious and time-consuming task of creating or adjusting an options trade, whether that be a single options contract, a simple spread, or a complex options strategy. In an example embodiment, an options trader, using an input device of a computing system, can bypass the arduous and tedious task of looking up options in tables, and instead add a desired option to a P&L graph by simply clicking (or otherwise indicating) directly on the P&L graph at a desired strike price. Once the options are indicated on the P&L graph, the options trader can use the GUI to drag the option from a first location on the P&L graph and drop the option at a different location on the P&L graph. During the drag and drop operation, the computing system that provides the GUI can calculate option quantities and strikes in order to provide an options P&L line which approximates the drop location. For instance, dragging up adds short options (equivalent to less longs), dragging down adds long options (equivalent to less shorts). Dragging left moves the options to a lower strike price, dragging right moves the options to a higher strike price. As spreads and complex strategies are created on the P&L graph, dragging one option can in turn update adjacent option quantities in order to maintain margin risk.

As explained more fully below, an option can be dragged and dropped directly on a P&L graph in a manner similar to the manner in which an object can be manipulated in a computer automated design (CAD) application or a presentation creation application. However, when the option is manipulated, the computing system can update a P&L line corresponding to the option and the quantity of the option based on rules which govern options. As such, the GUI methods and systems herein provide a specific implementation of a solution to a problem in the software arts, namely, how to analyze and manipulate options strategies in a manner that is intuitive, rapid, and robust enough to handle a multitude of options strategies.

The GUI improvements disclosed herein are applicable to many types of securities options, including but not limited to: index options, stock options, non-standard options, futures options, American expiration options, and European expiration options.

Further, the various aspects of the present disclosure can be implemented on numerous types of computing systems, such as the computing system described below.

### II. Example Operations

In line with the discussion above, a computing system can provide a GUI via which a user can create and manipulate an options strategy. In an example scenario, the user can initially select if puts or calls will be analyzed, and an expiration date. This selection can occur by way of selecting a radial button, use of a drop-down menu, inputting text, or another suitable input mechanism of the GUI. Then, the user can add an option to the P&L graph at a desired strike price. For instance, the user can double-click a mouse on the P&L graph at an x-coordinate. The x-coordinate can correspond to an underlying asset price as indicated on an x-axis of the P&L graph. The computing system can determine, from among a predefined list of strike prices, a strike price that is closest to the x-coordinate, and cause the GUI to display an indication of the option having that strike price on the P&L graph.

Once the option is indicated on the P&L graph, using the mouse as a pointing device, the user can drag the indicated option to a desired location. During the drag operation, the computing system can dynamically interpret the x-coordinate (underlying asset price) and the y-coordinate (financial result, i.e., option's profit or loss at expiration) of the mouse pointer. Using the x-coordinate, the computing system can find the closest option strike price to the x-coordinate from a predefined list of strike prices. With that strike price, the computing system can then retrieve the current options price (e.g., from a server in a network using an application programming interface (API) call or similar request). With that options price, the computing system can then calculate the quantity of options, to the nearest multiple, which would match the y-coordinate of the mouse. As part of this calculation, the computing system can designate the option as a long position or a short position, depending on whether the y-coordinate corresponds to a profit or a loss. With the strike price, the options price, and the quantity of options, the computing system can graph the option's P&L line on the P&L graph concurrent with the drag operation. As the mouse is dragged, the option's P&L line and an indication of the quantity can be continuously updated on the P&L graph to match the mouse pointer x-coordinate and y-coordinate. For instance, the quantity of the desired option can be updated based on a current financial result (e.g., profit or loss corresponding to a current y-coordinate) and a current strike price (e.g., strike price corresponding to a current x-coordinate). Once the user drags the options to a desired location, releasing the mouse button drops (sets) the option's P&L line at the corresponding mouse coordinates. Additional options can be added to the P&L graph by repeating the above process.

Although portions of this disclosure refer to an input device in the form of a computer mouse, the examples are not meant to be limiting. The systems and methods are also applicable to GUIs that are controlled using other input mechanisms, such as a GUI provided on a touchscreen that is manipulated by a user's finger(s) or a pointer.

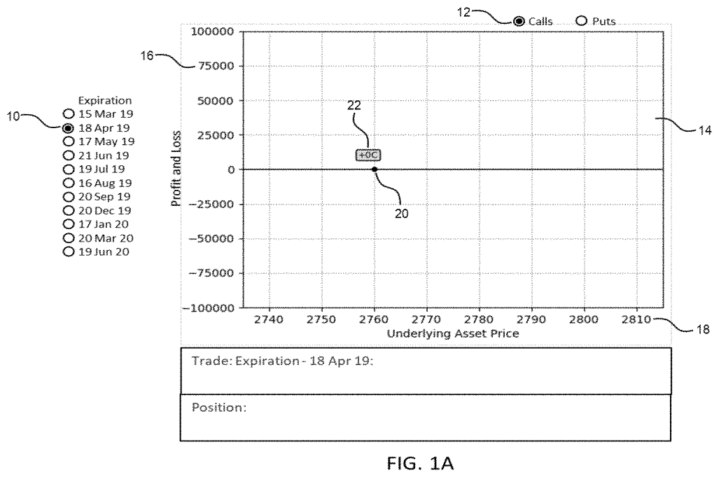

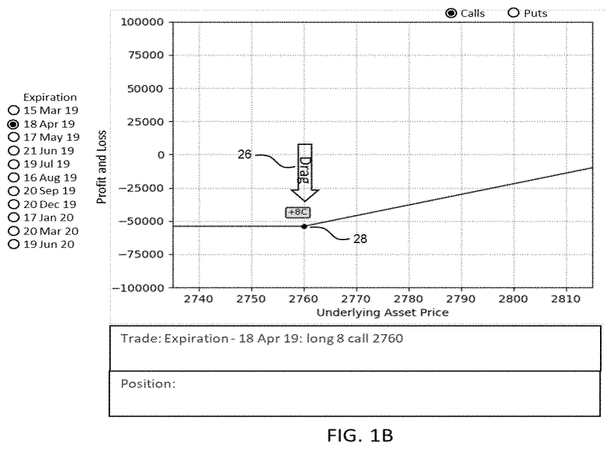

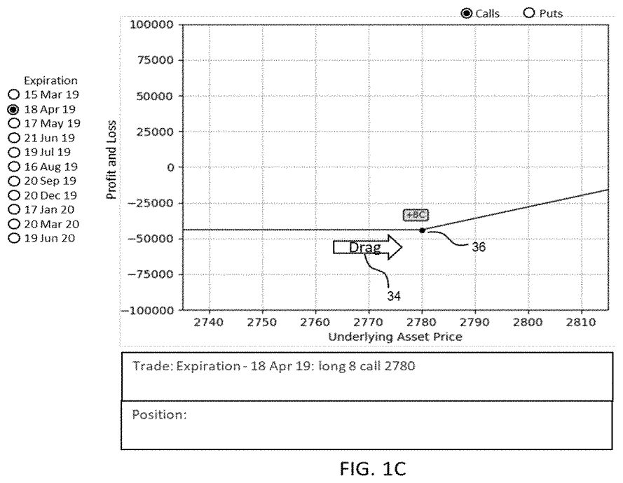

FIGS. 1A-1C depict an embodiment in which a call option is added to a P&L graph. As shown in FIG. 1A, the user intends to create a long call option on the P&L graph. A GUI, comprising of a P&L graph 14 with an x-axis 18 of the underlying asset price and a y-axis 16 showing the profit and loss of the option at expiration, is used. The user starts by selecting the expiration month 10 and selects calls 12. Then the user double clicks the mouse on the P&L graph at x-coordinate of approximately 2760 and y-coordinate of approximately 0. The computing system interprets the x-coordinate of the mouse and finds the closest strike price from a predefined list of strike prices. Since 2760 is the closest strike price the computing system indicates a 2760 call option 20 at 2760 with an optional label 22. Label 22 can indicate the quantity and whether the option is a long position or a short position. The indicated call option initially has a quantity of zero.

After the option is indicated on the P&L graph, as shown in FIG. 1B, the user uses the mouse to drag the call option directly down at operation 26 to approximately −52000 on the y-coordinate while keeping the x-coordinate unchanged. The computing system interprets the x-coordinate which remains at 2760 and retrieves the 2760 call options price (e.g., from a server in a network) which is $6745. The computing system then calculates how many 2760 call options are required, to the nearest multiple, to equal the mouse y-coordinate of −52000, which is eight call options (8×−6745=−53960). The computing system then draws the profit and loss lines 28 for eight long call options at strike 2760 on the P&L graph.

After the call option is dragged down, as shown in FIG. 1C, the user decides the call option should be moved to the right. The user uses the mouse to drag the call option right at operation 34 to the x-coordinate of approximately 2780 and the y-coordinate of approximately 45000. The computing system, using the x-coordinate from the mouse of 2780, retrieves the closest strike from a predefined list of strike prices. Since 2780 is the closest strike the computing system then retrieves the options price for a 2780 call option which is $5490. The computing system then calculates how many 2780 call options are required, to the nearest multiple, to equal the mouse y-coordinate of −45000 which is eight call options (8×−5490=−43920). The computing system then updates the profit and loss lines 36 for eight long call options at strike 2780.

In some examples, the user can convert the trade shown below the P&L graph to a description of the trade. For instance, the user can push a button on the GUI (not shown), which causes the computing system to output a description of the trade. The description can specify an option type, expiration date, strike price, and quantity. The description can take the form of a text file, for instance.

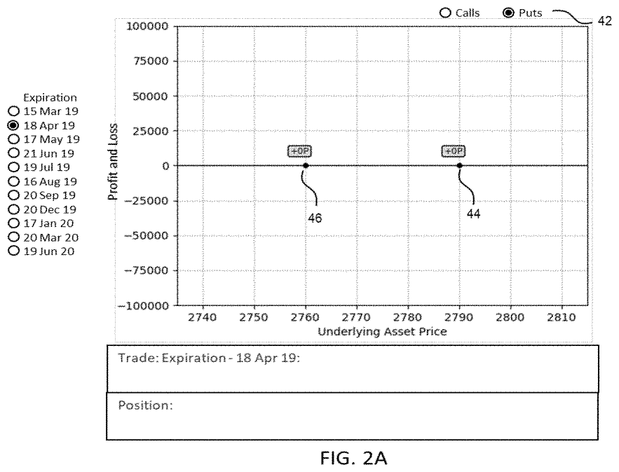

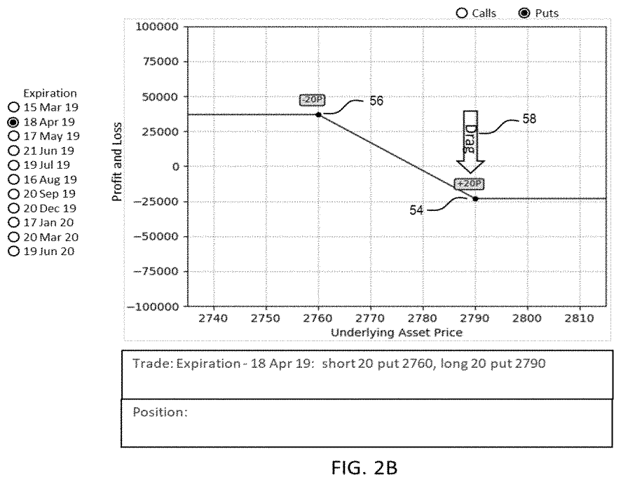

FIGS. 2A-2B depict an embodiment in which a put vertical spread is added to a P&L graph. As shown in FIG. 2A, the user selects puts 42. The user then double clicks the mouse on the P&L graph at x-coordinate of approximately 2760 and y-coordinate of approximately 0. Using the x-coordinate of 2760 from the mouse the computing system looks in a predefined list of strike prices and finds 2760 is the closest strike and indicates a put option 46 on the P&L graph at strike price 2760. The user repeats the process at x-coordinate of 2790 and y-coordinate of 0 and the computing system indicates another put option 44 at 2790. Both put options initially have a quantity of zero.

After the put options are indicated, as shown in FIG. 2B, the user uses the mouse to drag the 2790 put option directly down at operation 58 to approximately −23000 for the y-coordinate while keeping the x-coordinate unchanged. The computing system interprets the x-coordinate of the mouse which remains at 2790 and retrieves the 2790 put option price which is $6340. The computing system also sees there are adjacent puts on the P&L graph at 2760 and also retrieves the 2760 put option price from the network which is $5185. In a vertical spread configuration adjacent options are opposite, that is, if one option is a long then the adjacent option is a short and visa-versa. Therefore the multiple then becomes the difference between the put option price and the adjacent put option price which is 1155 (6340−5185=1155). The computing system calculates it will take twenty multiples (20×−1155=−23100) to equal the mouse y-coordinate of −23000. Since each multiple has in it one 2790 put option then the result is twenty 2790 long put options. To make a vertical spread, the adjacent options will have the opposite quantity which is twenty 2760 short put options. The computing system then draws the profit and loss lines 54, 56 for twenty 2670 2790 put vertical spreads.

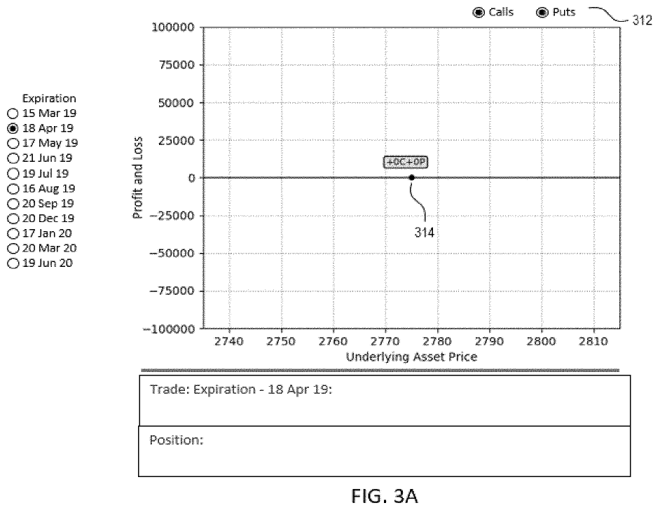

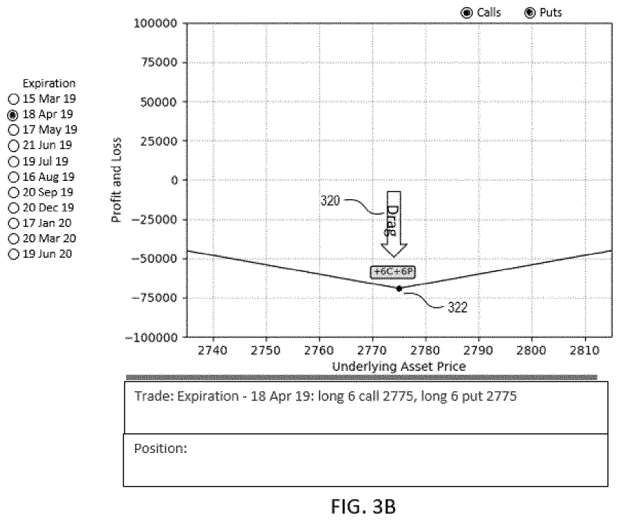

FIGS. 3A-3B depict an embodiment in which puts and calls are added to a P&L graph to create a straddle. As shown in FIG. 3A, the user first selects both puts and calls 312. The user then double clicks the mouse on the P&L graph at the x-coordinate of approximately 2775 and y-coordinate of approximately 0. Using the x-coordinate of 2775 the computing system looks in a predefined list of strike prices and finds 2775 is the closest strike and indicates both a put option and a call option 314 on the P&L graph at 2775. The indicated put option and call option initially have a quantity of zero.

After the put and call options are indicated, as shown in FIG. 3B, the user then uses the mouse to drag the puts and calls directly down at operation 320 to approximately −70000 for the y-coordinate while keeping the x-coordinate unchanged. The computing system interprets the x-coordinate of the mouse which remains at 2775 and retrieves the 2775 put option price and the 2775 call option price, which are $5730 and $5790 respectively. The computing system then calculates how many 2775 put options and 2775 call options are required to the nearest multiple based on the mouse y-coordinate of −70000 which is six put options and six call options (6*(−5730−5790)=−69120). The computing system then draws the profit and loss lines 322 for six long put and six long call options at strike 2775.

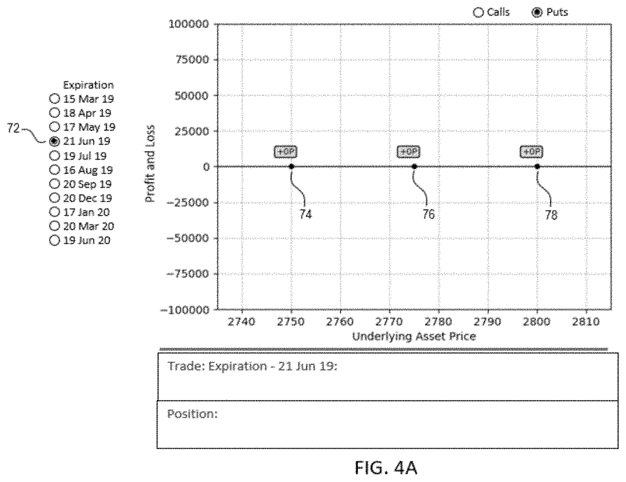

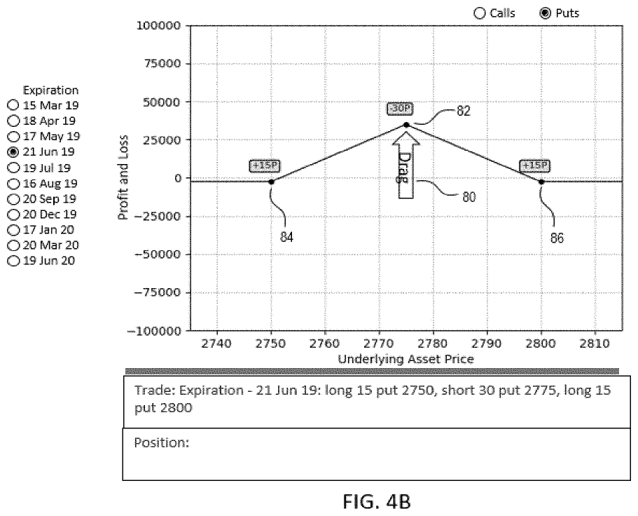

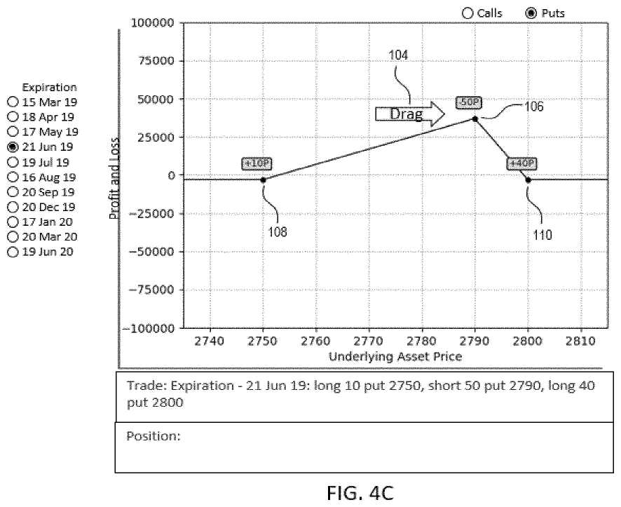

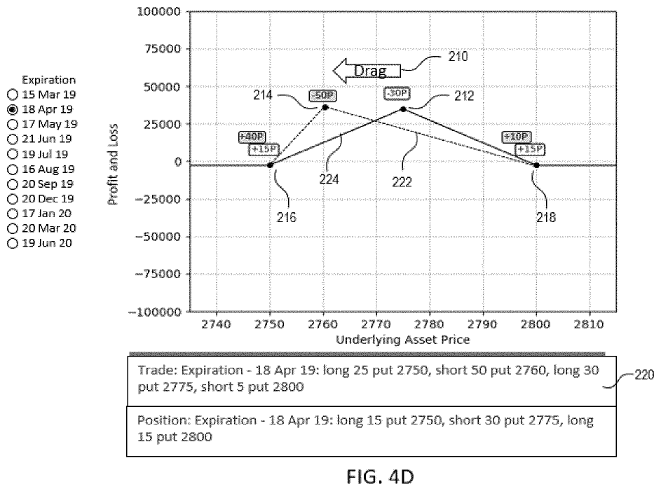

FIGS. 4A-4D depict an embodiment in which a put butterfly is added to a P&L graph. As shown in FIG. 4A, the user decides to create a butterfly on the P&L graph with an expiration date of Jun. 21, 1919. The user first selects an expiration date of Jun. 21, 1919 72. The user then double clicks the mouse on the P&L graph at x-coordinate of approximately 2750 and y-coordinate of approximately 0. Using the x-coordinate of 2750 the computing system looks in a predefined list of strike prices and finds 2750 is the closest strike and indicates a put option 74 on the P&L graph at 2750. The user repeats the process at x-coordinates 2775 and 2800, with y-coordinate at 0, and the computing system indicates put options 76, 78 at 2775 and 2800, respectively. The three indicated put options initially have a quantity of zero.

After the put options are indicated, as shown in FIG. 4B, the user uses the mouse to drag the 2775 put option directly up at operation 80 to a location 82 corresponding to approximately 35000 for the y-coordinate while keeping the x-coordinate unchanged. The computing system interprets the x-coordinate of the mouse which remains at 2775 and retrieves the 2775 put options price which is $5730. The computing system also determines that there are adjacent puts on the P&L graph at locations 84, 86, corresponding to strike prices 2750 and 2800, respectively, and retrieves the put options price for each, which are $4845 and $6790, respectively. In a butterfly configuration the outer options are opposite of the center option, that is, if the center option is short then both outer options are long and visa-versa. In addition, a standard butterfly is balanced, that is the center option will have twice the quantity (but opposite) as either outer option. Both outer options will have the same quantity. Also, since these are put options, if an option to the right of the option being dragged changes quantity then the difference between that options strike and the strike of the option being dragged is included in the multiple calculation. The difference between the option strike at location 86 and the option at location is twenty five. Since this option represents one hundred shares of the underlying asset at expiration, then twenty five is multiplied by one hundred (25*100=2500). Therefore, the multiple for the drag operation becomes two times the center option price minus the two outer option prices plus the difference between the right option strike and the strike of the option being dragged which is 2325 (2*5730−4845−6790+2500=2325). The computing system calculates it will take fifteen multiples (15*2325=34875) to equal the mouse y-coordinate of 35000. Since each multiple has in it two 2775 put options, then the quantity of options at 2775 is two times fifteen multiples, which equals thirty (2*15=30) 2775 short put options. To make a butterfly, the outer options will have half the opposite quantity of thirty shorts, which is fifteen 2750 long put options and fifteen 2800 long put options. The computing system then draws the profit and loss lines for fifteen 2750, 2775, 2800 put butterflies.

After the 2775 put options are dragged up, as shown in FIG. 4C, the user decides an unbalanced butterfly is preferred. Using the mouse the user drags the 2775 put options to the right at operation 104 to a location 106 corresponding to approximately 2790 for the x-coordinate while keeping the y-coordinate unchanged. The computing system interprets the x-coordinate of the mouse at 2790 and looks in a predefined list of strike prices and finds 2790 is the closest strike. The computing system then retrieves the 2790 put option price. The computing system also determines that there are adjacent put options on the P&L graph at locations 108, 110, corresponding to strike prices 2750 and 2800, respectively, and retrieves their respective option prices. The drag operation to the right causes the butterfly to become unbalanced since the distance to the outer option strikes are no longer the same. Since a butterfly configuration is actually two verticals back to back where the shorts (or longs) are at the same strike, the computing system manages each side as a vertical spread as described in FIGS. 2A and 2B. The multiple for the y-coordinate is based on both spreads added together. The result is an unbalanced butterfly with the center short put option quantity equal to fifty at strike price 2790. Maintaining equivalent risk, the computing system calculated ten long put options are needed at 2750 108 and forty long put options are needed at 2800 110. The computing system updates the P&L graph with P&L lines of a 2750 2790 2800 unbalanced butterfly.

As shown in FIG. 4D, the user decided the butterfly configuration from FIG. 4B was a satisfactory strategy and entered a trade so the options became actual positions in the market. Then, sometime after the positions were created, the user decides to adjust the strategy into an unbalanced butterfly. The positions themselves cannot be moved with a drag and drop operation since they are actual positions in the market. However, a variation of the trade can be analyzed. The user uses the mouse to drag at operation 210 the put position options which are at strike 2775 from a first location 212 to a second location 214 corresponding to approximately 2760 for the x-coordinate while keeping the y-coordinate unchanged. As stated, the position does not move, so the computing system does not update the position profit and loss line. However, based on receiving the operation 210, the computing system draws another trade as a dotted line 222 in addition to the positions. Adjacent positions at locations 216, 218 also show a trade with updated quantities. The actual positions are indicated on the P&L graph by the solid line 224 and the new trade is indicated by the dotted line 222. The added or subtracted options to create the new trade are calculated by the computing system, which is the difference between the new trade 220 and the existing positions.

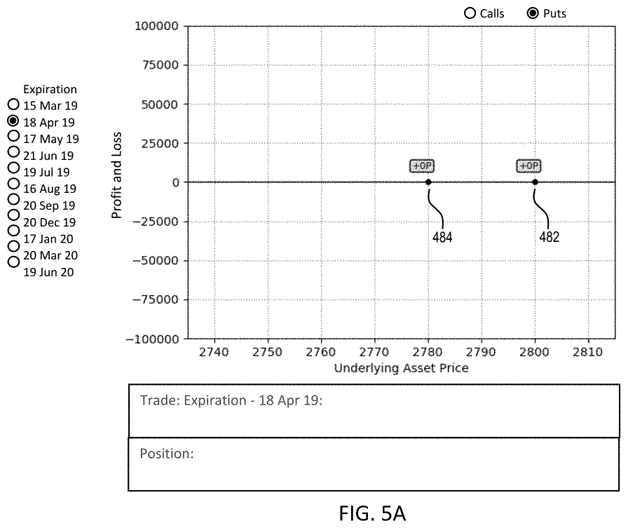

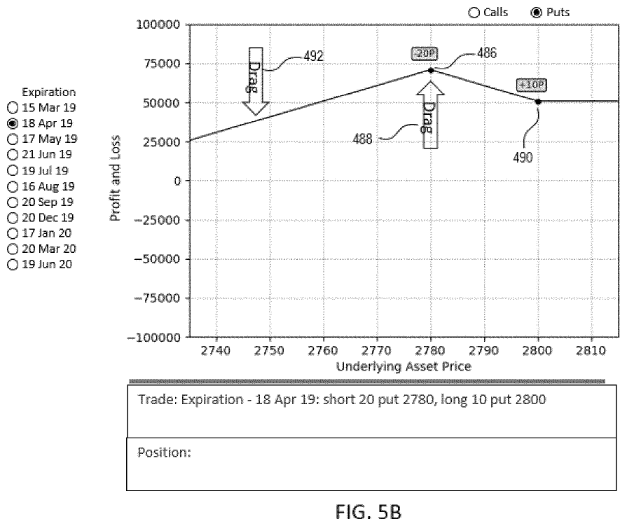

FIGS. 5A-5B depict an embodiment in which puts are added to a P&L graph to create a ratio spread. As shown in FIG. 5A, the user starts by selecting puts. The user then double clicks the mouse on the P&L graph at x-coordinate of approximately 2780 and y-coordinate of approximately 0. Using the x-coordinate of 2780 the computing system looks in a predefined list of strike prices and finds 2780 is the closest strike and indicates a put option 484 on the P&L graph at 2780 484. The options trader repeats the process at x-coordinates 2800 and y-coordinate at 0 and the computing system indicates another put option 482 at 2775. Both indicated put options initially have a quantity of zero.

After the put options are indicated, as shown in FIG. 5B, the user uses the mouse to drag the 2780 put option directly up at operation 488 to approximately 12000 for the y-coordinate while keeping the x-coordinate unchanged. The computing system interprets the x-coordinate of the mouse which remains at 2780 and retrieves the 2780 put option price. The computing system also sees there are adjacent puts on the P&L graph to the right at location 490, and retrieves the 2800 put option price. With this information, the computing system draws ten 2780 2800 put vertical spreads with the same logic explained in FIG. 2B.

After the first drag operation is completed, the options trader uses the mouse to drag the P&L line, which is to the left of the vertical spread, down at operation 492. The computing system interprets that an option P&L line is being dragged rather than an option. The program interprets that there are only put options to the right of the line drag location and no options to the left. The computing system, using the 2780 put option 486, retrieves the put option price. The computing system starts adding short puts options at strike 2780 as the line is dragged and updates the P&L line accordingly. The user stops the drag operation when the quantity of shorts at 2780 reaches minus twenty.

In some examples, if the user intends to move only part of the total quantity of the options indicated at any specific strike price, the user, using the mouse, could right click on said options on the P&L graph and a popup window would provide a means of selecting any amount of options for the drag and drop operation.

Further, in some examples, if the user intends to delete indicated options, the options trader, using the mouse, could right click on said options on the P&L graph and a popup window would provide a means of deleting said options.

### III. Example Architecture

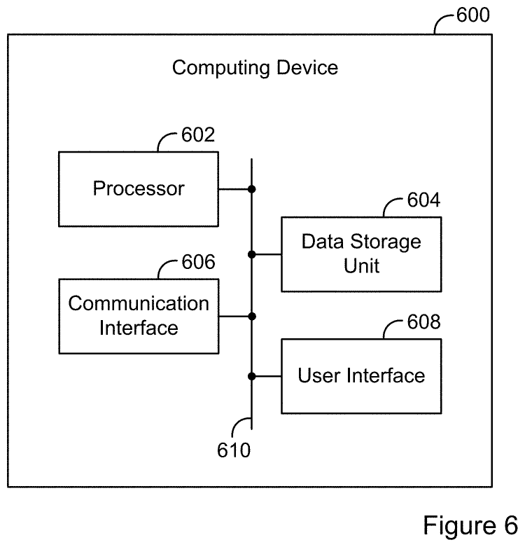

FIG. 6 is a simplified block diagram of an example computing device. Computing device 600 can perform various acts and/or functions, such as those described in this disclosure. Computing device 600 can include various components, such as processor 602, data storage unit 604, communication interface 606, and/or user interface 608. These components can be connected to each other (or to another device, system, or other entity) via connection mechanism 610.

Processor 602 can include a general-purpose processor (e.g., a microprocessor) and/or a special-purpose processor (e.g., a digital signal processor (DSP)).

Data storage unit 604 can include one or more volatile, non-volatile, removable, and/or non-removable storage components, such as magnetic, optical, or flash storage, and/or can be integrated in whole or in part with processor 602. Further, data storage unit 604 can take the form of a non-transitory computer-readable storage medium, having stored thereon program instructions (e.g., compiled or non-compiled program logic and/or machine code) that, when executed by processor 602, cause computing device 600 to perform one or more acts and/or functions, such as those described in this disclosure. As such, computing device 600 can be configured to perform one or more acts and/or functions, such as those described in this disclosure. Such program instructions can define and/or be part of a discrete software application. In some instances, computing device 600 can execute program instructions in response to receiving an input, such as from communication interface 606 and/or user interface 608. Data storage unit 604 can also store other types of data, such as those types described in this disclosure.

Communication interface 606 can allow computing device 600 to connect to and/or communicate with another entity according to one or more protocols. In one example, communication interface 606 can be a wired interface, such as an Ethernet interface or a high-definition serial-digital-interface (HD-SDI). In another example, communication interface 606 can be a wireless interface, such as a cellular or WI-FI interface. In this disclosure, a connection can be a direct connection or an indirect connection, the latter being a connection that passes through and/or traverses one or more entities, such as a router, switcher, or other network device. Likewise, in this disclosure, a transmission can be a direct transmission or an indirect transmission.

User interface 608 can facilitate interaction between computing device 600 and a user of computing device 600, if applicable. As such, user interface 608 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system. More generally, user interface 608 can include hardware and/or software components that facilitate interaction between computing device 600 and the user of the computing device 600.

### IV. Example Method

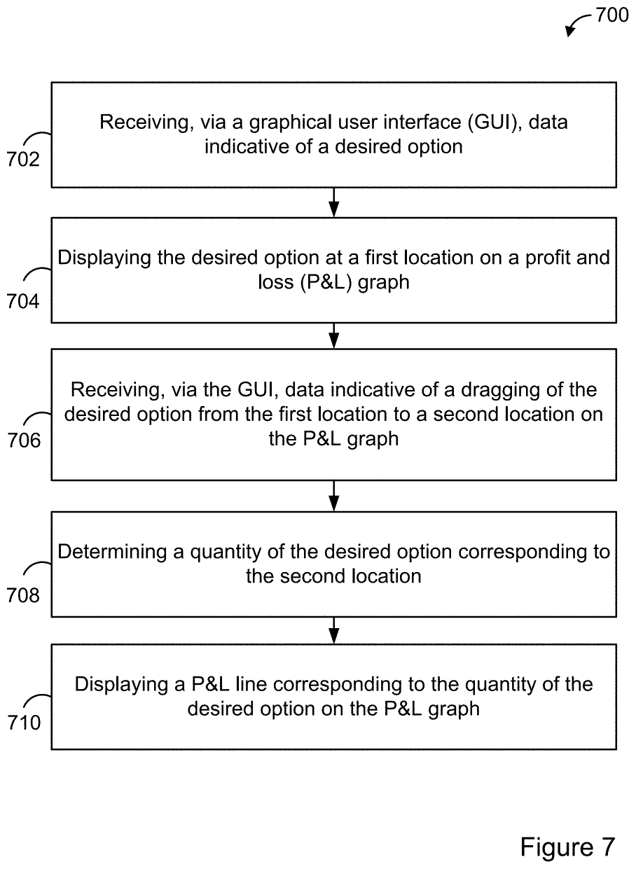

FIG. 7 is a flow chart of an example method. Method 700 can be carried out by a computing device, such as computing device 600 of FIG. 6, or more generally, by a computing system. At block 702, method 700 includes receiving, via a GIU, data indicative of a desired option. At block 704, method 700 includes displaying the desired option at a first location on a P&L graph. At block 706, method 700 includes receiving, via the GUI, data indicative of a dragging of the desired option from the first location to a second location on the P&L graph. At block 708, method 700 includes determining a quantity of the desired option corresponding to the second location. And at block 710, method 700 includes displaying a P&L line corresponding to the quantity of the desired option on the P&L graph.

### V. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A method comprising:
receiving, via a graphical user interface (GUI) of a computing system, data indicative of a desired option;
displaying, by the computing system, the desired option at a first location on a profit and loss (P&L) graph;
receiving, via the GUI of the computing system, data indicative of a dragging of the desired option from the first location to a second location on the P&L graph;
determining, by the computing system, a quantity of the desired option corresponding to the second location; and
displaying, by the computing system, a P&L line corresponding to the quantity of the desired option on the P&L graph.

2. The method of claim 1, wherein the data indicative of the desired option comprises an option type, an expiration date, and a strike price.

3. The method of claim 2, wherein:
the second location corresponds to a financial result, and
determining the quantity of the desired option comprises determining the quantity based on: (i) the financial result and (ii) an option price of the desired option at the strike price.

4. The method of claim 3, further comprising determining the option price of the desired option at the strike price.

5. The method of claim 3, further comprising designating the option as a long position or a short position based on the financial result.

6. The method of claim 1, wherein:
the first location corresponds to a first strike price,
the second location corresponds to: (i) a second strike price that is different from the first strike price and (ii) a financial result, and
determining the quantity of the desired option comprises determining the quantity based on: (i) an option price of the desired option at the second strike price and (ii) the financial result.

7. The method of claim 1, wherein displaying the P&L line comprises displaying an indication of the quantity of the desired option.

8. The method of claim 7, wherein displaying the indication of the quantity of the desired option comprises dynamically updating the indication of the quantity of the desired option during dragging of desired option based on a current financial result and a current strike price corresponding to a current location of the desired option on the P&L graph.

9. The method of claim 1, further comprising:
receiving, via the GUI of the computing system, data indicative of an adjacent option;
displaying, by the computing system, the adjacent option on the P&L graph; and
determining, by the computing system, a quantity of the adjacent option based on the quantity of the desired option,
wherein the P&L line corresponds to both the quantity of the desired option and the quantity of the adjacent option.

10. The method of claim 9, wherein determining the quantity of the desired option comprises determining the quantity of the desired option based on an option price of a strike price of the desired option and an option price of a strike price of the adjacent option.

11. The method of claim 9, wherein determining the quantity of the adjacent option based on the quantity of the desired option minimizes change to the margin requirements of an overall spread.

12. The method of claim 9, wherein displaying the P&L line comprises displaying an indication of the quantity of the adjacent option.

13. A computing system comprising:
one or more processors; and
a non-transitory computer-readable medium having stored thereon instructions that are executable to cause the computing system to perform a set of acts comprising:
receiving, via a graphical user interface (GUI), data indicative of a desired option,
displaying the desired option at a first location on a profit and loss (P&L) graph,
receiving, via the GUI, data indicative of a dragging of the desired option from the first location to a second location on the P&L graph,
determining a quantity of the desired option corresponding to the second location, and
displaying a P&L line corresponding to the quantity of the desired option on the P&L graph.

14. The computing system of claim 13, wherein the data indicative of the desired option comprises an option type, an expiration date, and a strike price.

15. The computing system of claim 14, wherein:
the second location corresponds to a financial result, and
determining the quantity of the desired option comprises determining the quantity based on: (i) the financial result and (ii) an option price of the desired option at the strike price.

16. The computing system of claim 13, wherein:
the first location corresponds to a first strike price,
the second location corresponds to: (i) a second strike price that is different from the first strike price and (ii) a financial result, and
determining the quantity of the desired option comprises determining the quantity based on: (i) an option price of the desired option at the second strike price and (ii) the financial result.

17. The computing system of claim 13, wherein the set of acts further comprise:
receiving, via the GUI, data indicative of an adjacent option;
displaying the adjacent option on the P&L graph; and
determining a quantity of the adjacent option based on the quantity of the desired option, and
wherein the P&L line corresponds to both the quantity of the desired option and the quantity of the adjacent option.

18. A non-transitory computer-readable medium having stored thereon program instructions that upon execution by a processor, cause performance of a set of acts comprising:
receiving, via a graphical user interface (GUI), data indicative of a desired option,
displaying the desired option at a first location on a profit and loss (P&L) graph,
receiving, via the GUI, data indicative of a dragging of the desired option from the first location to a second location on the P&L graph,
determining a quantity of the desired option corresponding to the second location, and
displaying a P&L line corresponding to the quantity of the desired option on the P&L graph.

19. The non-transitory computer-readable medium of claim 18, wherein the data indicative of the desired option comprises an option type, an expiration date, and a strike price.

20. The non-transitory computer-readable medium of claim 19, wherein:
the second location corresponds to a financial result, and
determining the quantity of the desired option comprises determining the quantity based on: (i) the financial result and (ii) an option price of the desired option at the strike price.
